(19) United States
(12) Patent Application Publication
(10) Pub. No.: US 2026/0030721 A1
(43) Pub. Date: Jan. 29, 2026

(54) IMAGE PROCESSING METHOD, ELECTRONIC DEVICE, AND COMPUTER-READABLE STORAGE MEDIUM

(71) Applicant: MASHANG CONSUMER FINANCE CO., LTD., Chongqing (CN)

(72) Inventor: Yejiang ZHOU, Chongqing (CN)

(21) Appl. No.: 19/272,710

(22) Filed: Jul. 17, 2025

(30) Foreign Application Priority Data
Jul. 23, 2024 (CN) 202410997196.X

(51) Int. Cl. G06T 3/40; G06T 5/50; G06T 5/60; G06T 5/70

(52) U.S. Cl. CPC G06T 3/40; G06T 5/50; G06T 5/60; G06T 5/70; G06T 2207/20081

(57) ABSTRACT

An image processing method, an electronic device, and a computer-readable storage medium are provided. The image processing method includes that: a first encoding process is performed on a first image and a second image to obtain a first image feature and a second image feature, an interpolation process is performed on the first image feature and the second image feature to obtain a first interpolated feature, a decoding process is performed on the first interpolated feature to obtain a transition image, and the transition image is inserted between the first image and the second image.

### CROSS-REFERENCE TO RELATED APPLICATION

This application claims the benefit of priority of Chinese Patent Application No. 202410997196.X, filed on Jul. 23, 2024, the contents of which are incorporated herein by reference in its entirety for all purposes.

### BACKGROUND

Interpolation, usually referred to as inner Interpolation, is a term in image processing. The essence of interpolation lies on estimating unknown data by using known data. Image interpolation refers to generating new image or images between two input images through a method of “interpolation”. The principle of image interpolation is similar to the principle of fitting, both of which are important parts of function approximation or numerical approximation. But the difference between interpolation and fitting is that: for a given function, interpolation requires discrete points to “lie on” a curve of the function to meet constraints, whereas fitting aims to have the discrete points “approximate” the curve of the function as closely as possible.

### SUMMARY

Embodiments of the present disclosure provide an image processing method, an electronic device, and a computer-readable storage medium.

According to a first aspect, an embodiment of the present disclosure provides an image processing method, which includes the following operations.

A first encoding process is performed on a first image and a second image to obtain a first image feature and a second image feature.

An interpolation process is performed on the first image feature and the second image feature to obtain a first interpolated feature.

A decoding process is performing on the first interpolated feature to obtain a transition image, and the transition image is inserted between the first image and the second image.

According to a second aspect, an embodiment of the present disclosure provides an electronic device, which includes a processor and a memory configured to store computer-executable instructions. The computer-executable instructions are configured to be executed by the processor. The computer-executable instructions include operations for performing the image processing method provided in the first aspect above.

According to a fourth aspect, an embodiment of the present disclosure provides a computer-readable storage medium for storing computer-executable instructions, and the executable instructions cause a computer to perform the image processing method provided in the first aspect.

### BRIEF DESCRIPTION OF THE DRAWINGS

In order to more clearly explain one or more embodiments in the present disclosure or technical solutions in the prior art, drawings that need to be used in the description of the embodiments or the prior art will be briefly introduced below. It is obvious that the drawings in the following description are only some embodiments recited in one or more embodiments of the present disclosure. For those skilled in the art, other drawings may be obtained from these drawings without making creative labor.

FIG. 1 is a schematic flowchart of an image processing method according to an embodiment of the present disclosure.

FIG. 2 is a schematic structural diagram of an image processing model according to an embodiment of the present disclosure.

FIG. 3 is a schematic diagram of an image interpolation according to an embodiment of the present disclosure.

FIG. 4 is a schematic diagram of an image interpolation according to an embodiment of the present disclosure.

FIG. 5 is a schematic diagram of an application scenario of an image processing method according to an embodiment of the present disclosure.

FIG. 6 is a schematic structural diagram of an image processing apparatus according to an embodiment of the present disclosure.

FIG. 7 is a schematic structural diagram of an electronic device according to an embodiment of the present disclosure.

### DETAILED DESCRIPTION

Hereinafter, technical solutions in embodiments of the present disclosure will be clearly and completely described with reference to the drawings in the embodiments of the present disclosure. It is obvious that the described embodiments are part of the embodiments of the present disclosure, but not all the embodiments of the present disclosure. Based on the embodiments in this specification, all other embodiments obtained by those skilled in the art without making creative efforts fall within the protection scope of this document.

The terms “first”, “second”, and the like in the specification and claims of this document are used to distinguish similar objects and are not used to describe a particular order or sequence. It should be understood that the data so used may be interchangeable where appropriate so that the embodiments of the present disclosure may be implemented in an order other than those illustrated or described herein, and that objects distinguished by using “first”, “second”, etc. generally belong to one category and the number of objects is not limited. For example, the first object may be one or more. In addition, “and/or” in the specification and claims indicates at least one of the connected objects, and the character “/” generally indicates an “or” relationship between the associated objects.

Hereinafter, an image processing method, an apparatus, a device, a storage medium, and a program product according to the embodiments of the present disclosure will be described in detail through specific embodiments and application scenarios thereof with reference to the accompanying drawings.

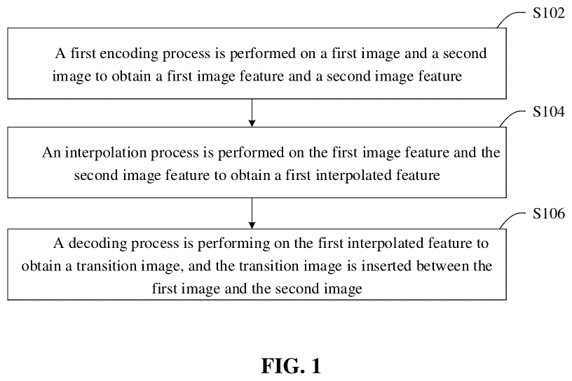

FIG. 1 illustrates an image processing method according to an embodiment of the present invention. The method may be executed by an electronic device. The electronic device may include a server and/or a terminal device. The terminal device may be, for example, a vehicle terminal, a mobile phone terminal, or the like. In other words, the method may be executed by software or hardware installed on the aforementioned electronic devices. The method includes operations S102-S106.

At S102, a first encoding process is performed on a first image and a second image to obtain a first image feature and a second image feature.

The first image and the second image are images used to generate an interpolated image. After an instruction for generating an interpolated image is received, an interpolated image (i.e., a transition image) whose features lie between features (such as styles and textures) of the first image and the second image may be generated according to the features (such as styles and textures) of the first image and the second image indicated by the generation instruction. In the present disclosure, the magnitude of the difference between the features (such as styles and textures) of the first image and the second image is not specifically limited, and may be determined according to the actual situation.

The first encoding process may be an operation of mapping a two-dimensional image to a high-dimensional latent space. The image may be converted into the image feature through the first encoding process. The first image feature is an image feature obtained by performing the first encoding process on the first image, and the second image feature is an image feature obtained by performing the first encoding process on the second image.

It should be noted that the first encoding process is different from a processing method of a Convolutional Neural Network (CNN). The CNN performs a compression process and a mapping process on images at the same time. While the first encoding process in the present disclosure does not include the compression process, and in the process of the first encoding process, it is necessary to ensure that the size of the shape of the image feature is with the same as that of the original image, which will help to ensure that the size of the transition image obtained in the subsequent operation S106 is with the same as the sizes of the first image and the second image, and improve the effect of the transition image generated by the image processing process. In the present disclosure, dimension parameters of the latent space (that is, dimensions of the first image feature and the second image feature) are not specifically limited, and may be determined according to the practical situation. For example, the dimension parameter may be 1000 or 2000, etc.

In an example, an encoder in Variational Auto-Encoders (VAEs) may be used to perform a first encoding process on the first image and the second image to map the first image and the second image to a latent space, so as to obtain the first image feature and the second image feature.

At S104, an interpolation process is performed on the first image feature and the second image feature to obtain a first interpolated feature.

The interpolation process is used to acquire an image feature (i.e. the first interpolated feature) between the first image feature and the second image feature. The first interpolated feature is used to characterize information contained in a transition image between the first image and the second image.

With the first encoding process in operation S102, the two-dimensional first image is converted into a high-dimensional first image feature and the two-dimensional second image is converted into a high-dimensional second image feature. In this way, for the first image feature and the second image feature, information such as global information and details in the original images (the first image and the second image) is removed, and only some important features in the original image are retained, which makes the distributions of features represented by the first image feature and the second image feature similar, and thus is beneficial to realize the generation of a transition image between any two images.

In an example, the interpolation process between the first image feature and the second image feature may be performed directly in the latent space. Specifically, the process may include that: the first image feature and the second image feature (both of which are in the form of matrix) are converted into corresponding vectors (i.e., row vectors); then interpolation process is realized by interpolating between the two converted vectors. In the present disclosure, the method of interpolation process for the first image feature and the second image feature is not specifically limited, and may be determined according to the practical situation. For example, the interpolation process may be a Linear Interpolation, a Nearest Neighbor Interpolation, or the like.

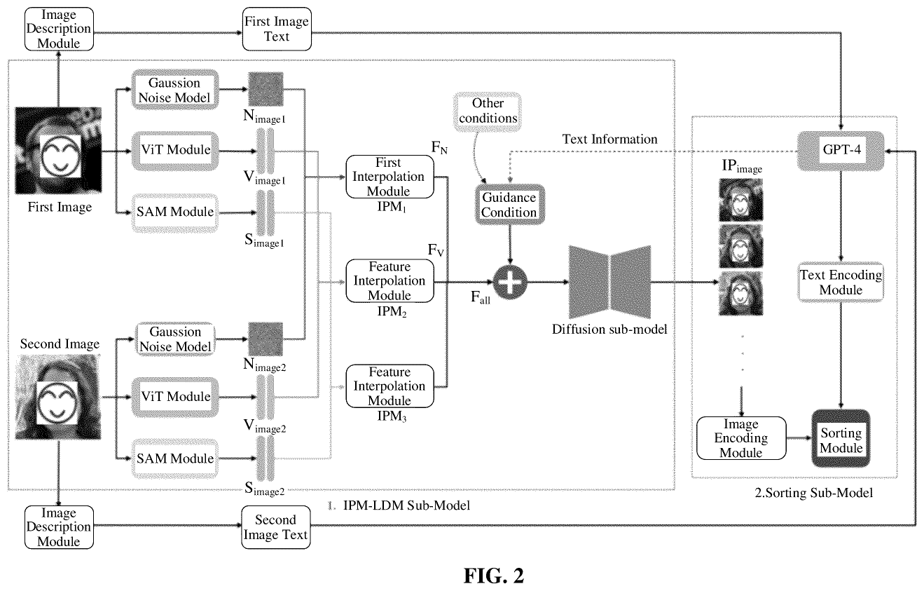

The image processing method described in the present disclosure may be used for an image processing model. FIG. 2 shows a schematic structural diagram of an image processing model. As shown in FIG. 2, an interpolation module (such as a first interpolation module IPM₁) for generating a first interpolated feature between two image features may be provided in the image processing model to realize the interpolation process for the first image feature and the second image feature.

Specifically, as shown in FIG. 2, a Linear Interpolation module IPM₁ as the first interpolation module may be provided in the image processing model. The first image feature and the second image feature may be input to the Linear Interpolation module IPM₁. Then, the Linear Interpolation module IPM₁ is used to perform Linear Interpolation calculation on the first image feature and the second image feature, and then the interpolated result is processed in the Linear Interpolation module IPM₁ by using the Multi-Layer Perceptron (MLP), to obtain the first interpolated feature F_{N}. The method for calculating the first interpolated feature F_{N} may be as shown in Formula 1.

$${F}_{N} = MLP ( LinearInterpolation ( {N}_{image 1} , {N}_{image 2} ) ) \qquad ( Formula 1 )$$

Here, N_{image1} represents a first image feature, N_{image2} represents a second image feature, F_{N} represents a first interpolated feature, LinearInterpolation(⋅) represents a linear interpolation operation, and MLP(⋅) represents processing using the MLP.

In order to improve the training efficiency of the image processing model, the first interpolation module in FIG. 2 may be a pre-trained model whose parameters do not need to be changed during the training process of the image processing model.

At S106, a decoding process is performed on the first interpolated feature to obtain a transition image, and the transition image is inserted between the first image and the second image.

Here, the decoding process may be an inverse operation of the first encoding process in operation S102. Specifically, the decoding process may be a process of inversely mapping the second image feature in the latent space into the transition image.

In the embodiments of the present disclosure, a first encoding process is performed on a first image and a second image which are to be interpolated, and an interpolation process is performed on the first image feature and the second image feature which are obtained through encoding, to obtain a first interpolated feature, and then a decoding process is performed on the first interpolated feature, to generate a transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

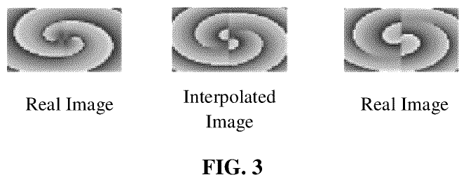

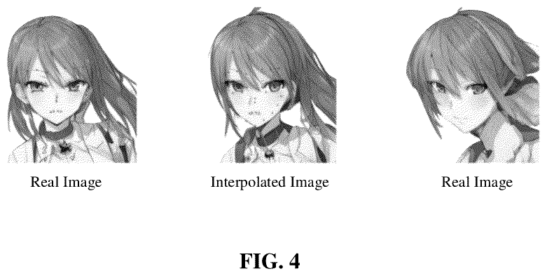

FIGS. 3 and 4 are schematic diagrams of image interpolation obtained by using the image processing method in the present disclosure. As shown in FIGS. 3 and 4, the image interpolation in FIGS. 3 and 4 is to generate a new interpolated image between two real images. The interpolated image has features, such as textures and styles, of the two real images, and the features of the interpolated image are between those of the two real images. The difference is that in FIG. 3, the interpolation is performed between similar images, and in FIG. 4, the interpolation is performed between images with large differences (for example, there are large differences in face angles, accessories, and hairstyles in FIG. 4).

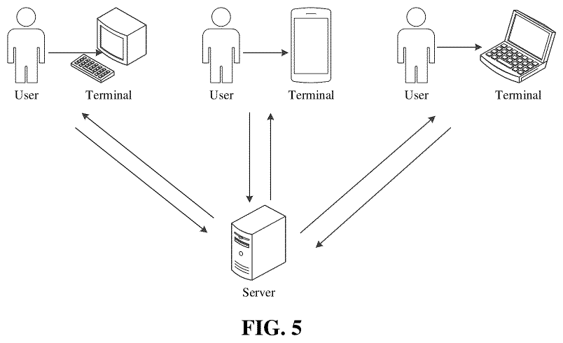

FIG. 5 provides a schematic diagram of an application scenario of an image processing method. As shown in FIG. 5, a user transmits a service request for generating a transition image between a first image and a second image to a server by using a terminal such as a mobile phone. After receiving the service request, the server obtains a transition image using the image processing method in the present disclosure, and transmits the transition image to the terminal for reference by the user.

As mentioned above, the first encoding process causes the image to lose part of the detailed information, thus facilitating the progress of the interpolation process. However, the first image feature and the second image feature obtained by using the first encoding process may still include some detailed information. In one implementation, the operation of performing the interpolation process on the first image feature and the second image feature to obtain the first interpolated feature includes the following operations.

Noise is added to the first image feature and the second image feature respectively to obtain a noise-added first image feature and a noise-added second image feature.

The interpolation process is performed on the noise-added first image feature and the noise-added second image feature to obtain the first interpolated feature.

Specifically, noise may be first added to the first image feature and the second image feature respectively, and then interpolation process may be performed on the noise-added first image feature and the noise-added second image to obtain the first interpolated feature. Alternatively, noise may be first added to the first image and the second image respectively; after the noise is added, the first image feature and the second image feature may be obtained; and then the first image feature and the second image feature may be interpolated to obtain the first interpolated feature.

In an example, the noise-added first image feature and the noise-added second image feature may be obtained by adding noise multiple times in succession to the first image feature and the second image feature respectively or adding noise directly once to the first image feature and the second image feature respectively. In the present disclosure, the method of adding noise and the details of adding noise, such as the number of times of adding noise, the type of noise, and the like, are not specifically limited, and may be selected according to the practical situation.

As shown in FIG. 2, Gaussian noise may be added to the first image and the second image respectively by using a Gaussian noise model as a noise module. Specifically, the Gaussian noise model may be used to first perform a first encoding operation on the first image and the second image to map the first image and the second image to a latent space, and then may add the Gaussian noise. The Gaussian noise models used by the first image and the second image may be the same. A manner of adding the noise by using the Gaussian noise model may be the same as that of adding the noise in a diffusion module, i.e., a Denoising Diffusion Probabilistic Model (DDPM). That is, an encoder in Variational Auto-Encoders (VAEs) may be used to map the image to a latent space, and then add noise to the first image and the second image in the latent space. The process of calculating the first image feature may be as shown in Formula 2:

$${N}_{image 1} = DDPM ( {I}_{1} , T ) \qquad ( Formula 2 )$$

Here, I₁ represents a first image input into the Gaussian noise model, DDPM(⋅) represents adding the Gaussian noise using the diffusion model DDPM, T represents the number of steps of adding the noise, and N_{image1} represents the first image feature after the noise is added, and the shape and size of this first image feature may be the same as that of the original image. The process of calculating the second image feature may be the same as that of calculating the first image feature, and will not be described in detail here.

In the above embodiment, the first image feature and the second image feature obtained after adding the noise lose global information and detail information in the first image and the second image feature, but the distance between the noise-added first image feature and the noise-added second image feature in the latent space is closer, so that the generation of an transition image between an arbitrary first image and an arbitrary second image may be better realized.

In one implementation, the operation that the decoding process is performed on the first interpolated feature to obtain a transition image includes the following operations.

A decoding condition for the first interpolated feature is acquired; and

Based on the decoding condition, the first interpolated feature is decoded by using a diffusion sub-module to obtain the transition image.

The decoding condition corresponds to a condition according to which inverse operations for the aforementioned first encoding process and the noise addition process are performed. Since the first interpolated feature is generated based on the noise-added first image and the noise-added second image, the transition image may be generated by performing the decoding process including a noise removal process on the first interpolated feature. Specifically, the denoising of the first interpolated feature may refer to denoising by predicting the noise added in the previous timestep, or denoising by predicting the feature in the previous timestep, but this is not specifically limited in the present disclosure.

Since the noise-added first image feature and the noise-added second image feature lose a lot of information in the original image (the first image and the second image), a lot of information in the first image and the second image is also lost in the first interpolated feature. In order to improve the effect (such as fidelity, etc.) of the generated transition image, a decoding condition may be set for the decoding process. The decoding condition may be used to guide the sampling and generation of the transition image, so that an object or the like in the transition image generated after the decoding process matches the object in the original image as much as possible.

In an example, partial information (such as a position, texture information, etc. of an object in an image) may be extracted from the first image and the second image as a decoding condition to guide the decoding process. Specifically, other decoding conditions such as category labels and keywords of the image may be set according to the display requirements for the transition image. The process of generating the decoding condition may be referred to subsequent embodiments, and the description thereof will not be repeated here.

Specifically, the decoding process including a denoising process or a noise reduction process may be implemented by the following algorithm architecture. The algorithm architecture may include three parts: a condition module that adds at least one denoising condition (i.e., at least one decoding condition), a diffusion module that performs the denoising process on image features with noise in the latent space, and a decoding module that maps the denoised image features from the latent space back to the pixel space. The conditions in the condition module may be type data such as a semantic condition Semantic Map (indicating that the processed task is generating an image by using semantics), a Text condition Text (indicating a task of generating an image by using Text), a description condition Representations (indicating a task of generating an image by using language description), and an image condition Images (indicating a task of generating an image from an image). The decoding module may be a decoder in the variational Auto-Encoders. The structure of the diffusion module may refer to a Stable Diffusion (SD) model, which is not described in detail here.

As shown in FIG. 2, a diffusion sub-model (Latent Diffusion Model, LDM) using the principle of the diffusion model DDPM may be set in the image processing model. The diffusion sub-model is used to convert the first interpolated feature into a transition image and output it.

In the above process, by decoding the first interpolated feature with noise by using the diffusion sub-model, the image interpolation task is transformed into an image generation task, and the interpolation operation for any two images is realized based on the noise-added first image feature and the noise-added second image feature with close distance, thus improving the robustness of the image processing model.

Since the first image feature and the second image feature lose global information, detail information, etc. of the first image and the second image, in order to improve the effect of the generated transition image, partial information of the first image and the second image may be added to the first image feature and the second image feature before the decoding process. In one implementation, the operation of decoding, based on the decoding condition, the first interpolated feature using the diffusion sub-model to obtain the transition image includes the following operations.

A second encoding process is performed on the first image and the second image respectively to obtain a third image feature and a fourth image feature.

An interpolation process is performed on the third image feature and the fourth image feature to obtain the second interpolated feature.

The first interpolated feature is adjusted based on the second interpolated feature to obtain the adjusted first interpolated feature.

Based on at least one decoding condition, the adjusted first interpolated feature is decoded by using the diffusion sub-model to obtain the transition image.

Similarly to the first encoding process, the second encoding process also includes an operation of mapping a two-dimensional image to a high-dimensional latent space. In addition, the second encoding process further includes a feature extraction operation for the image features obtained through mapping. That is, unlike the first image feature and the second image feature, the third image feature and the fourth image feature are image features obtained by further extracting features from the image features obtained through mapping. Specifically, the third image feature represents an image feature obtained by performing the second encoding process on the first image, and the fourth image feature represents an image feature obtained by performing the second encoding process on the second image. The latent spaces corresponding to the first encoding process and the second encoding process may be different, so that the generalization ability and robustness of the image processing method may be improved by supplementing the features in different latent spaces.

Further, after the third image feature and the fourth image feature are obtained, a method similar to the method of generating the first interpolated feature may be adopted to perform the interpolation process on the third image feature and the fourth image feature to obtain the second interpolated feature. Then, the second interpolated feature may be supplemented to the first interpolated feature, to adjust the first interpolated feature. Finally, the transition image may be generated by using the adjusted first interpolated feature.

Specifically, a weighted average may be used for the first interpolated feature and the second interpolated feature to obtain the second interpolated feature. In an example, before the first interpolated feature is decoded using the diffusion sub-model, the operation that the first interpolated feature is adjusted based on the second interpolated feature to obtain the adjusted first interpolated feature includes the following operations.

A first weight for the first interpolated feature and a second weight for the second interpolated feature are obtained; and

The adjusted first interpolated feature is obtained based on the first interpolated feature, the first weight, the second interpolated feature and the second weight.

In the present disclosure, the first weight corresponding to the first interpolated feature and the second weight corresponding to the second interpolated feature are not specifically limited, and may be determined according to the practical situation.

In order to achieve sufficient extraction of information with different types from the first image and the second image, in one implementation, the second encoding process includes M encoding types. M is a positive integer greater than 1. The operation that the second encoding process is performed on the first image and the second image respectively to obtain the third image feature and the fourth image feature includes the following operations.

Based on the M encoding types, the second encoding process is performed on the first image and the second image respectively to obtain M types of third image features and M types of fourth image features.

The operation that the interpolation process is performed on the third image feature and the fourth image feature to obtain the second interpolated feature includes an operation that the interpolation process is performed on a third image feature and a fourth image feature belonging to a same encoding type, to obtain M types of second interpolated features.

Specifically, M different second encoding processing procedures may be set for the first image and the second image. Each second encoding processing procedure may include mapping the first image and the second image to a latent space corresponding to the second encoding processing procedure (different second encoding processing procedures corresponds to different latent spaces), and performing a feature extraction operation on the mapped image features, so as to implement different types of second encoding processes for the first image and the second image in different latent spaces respectively. Each type of the second encoding processing procedures may correspond to a latent space and each type of the second encoding processing procedures may correspond to a set of a third image feature and a fourth image feature.

Further, the interpolation process may be performed on the third image feature and the fourth image feature corresponding to each type of second encoding processing procedure, respectively, to obtain the second interpolated feature corresponding to this second encoding processing procedure. In an example, the second encoding processing procedures may include two types: mapping the first image and the second image to a feature space corresponding to a instance feature, and extracting the instance feature (a feature of an object in the image, such as a face, etc.) from the mapped image features; mapping the first image and the second image respectively to a feature space corresponding to a global feature, and extracting the global feature from the mapped image features.

A Vision Transformer (ViT) is a neural network model based on self-attention mechanism. It uses a manner of attention to capture global context information to establish long-distance dependence on a target, thereby improving the ability of feature representation. As shown in FIG. 2, a ViT module may be provided in the image processing model. The ViT module may project the first image and the second image respectively into a global space through the second encoding process, and further may extract global features of the first image and the second image in the global space to obtain the third image feature characterizing global information of the first image and the fourth image feature characterizing global information of the second image. The process of calculating the third image feature corresponding to the global space may be as shown in Formula 3.

$${V}_{image 1} = Vit ( {I}_{1} ) \qquad ( Formula 3 )$$

Here, I₁ represents a first image input to the ViT module, V_{image1} represents a third image feature corresponding to the global space, and Vit(⋅) represents extracting the global feature. The process of calculating the fourth image feature corresponding to the global space may be the same as the process of calculating the third image feature corresponding to the global space, and will not be described in detail here. Like the first image feature and the second image feature, the third image feature corresponding to the global space and the fourth image feature corresponding to the global space each may have a same size in shape as the original image.

The Segment Anything model (SAM) is a model with extensive functionality in the field of image segmentation that is capable of being quickly adapted to many existing and emerging segmentation tasks (such as edge detection, object proposal generation, instance segmentation, and object segmentation from free-form text). As shown in FIG. 2, a SAM module may be provided in the image processing model. The SAM module may project the first image and the second image into the instance space through the second encoding process, and may further extract the instance features of the first image and the second image in the instance space to obtain a third image feature characterizing the instance information of the first image and a fourth image feature characterizing the instance information of the second image. Specifically, the SAM module may segment the object from the image features in the instance space, and then obtain the instance feature as the third image feature or the fourth image feature. The process of calculating the third image feature corresponding to the instance space may be as shown in Formula 4:

$${S}_{image 1} = SAM ( {I}_{1} ) \qquad ( Formula 4 )$$

Here, I₁ represents a first image input to the SAM module, S_{image1} represents a third image feature corresponding to a instance space, and SAM(⋅) represents extracting an instance feature from the instance space. The process of calculating the fourth image feature corresponding to the instance space may be the same as the process of calculating the third image feature corresponding to the instance space, and will not be described in detail here. Like the first image feature and the second image feature, the third image feature corresponding to the instance space and the fourth image feature corresponding to the instance space each may have the same size in shape as the original image.

After the third image feature and the fourth image feature corresponding to the global space and the third image feature and the fourth image feature corresponding to the instance space are obtained, similar to the calculation method for the first interpolated feature, linear interpolation calculation may be performed on the third image feature and the fourth image feature corresponding to the global space and the instance space based on Formula 5 and Formula 6, and then the respective interpolated features may be obtained by using a Multi-Layer Perceptron (MLP).

$${F}_{V} = MLP ( LinearInterpolation ( {V}_{image 1} , {V}_{image 2} ) ) \qquad ( Formula 5 )$$

Here, V_{image1} represents a third image feature corresponding to a global space, V_{image2} represents a fourth image feature corresponding to the global space, F_{V} represents a second interpolated feature corresponding to the global space, LinearInterpolation(⋅) represents a linear interpolation operation, and MLP(⋅) represents processing using MLP.

$${F}_{S} = MLP ( LinearInterpolation ( {S}_{image 1} , {S}_{image 2} ) ) \qquad ( Formula 6 )$$

Here, S_{image1} represents a third image feature corresponding to a instance space, S_{image2} represents a fourth image feature corresponding to the instance space, F_{S} represents a second interpolated feature corresponding to the instance space, LinearInterpolation(⋅) represents a linear interpolation operation, and MLP(⋅) represents processing using MLP.

When the feature space includes the global space and the instance space, a method of calculating the adjusted first interpolated feature may be as shown in Formula 7.

$${F}_{all} = 1 / 3 ( a * {F}_{N} + b * {F}_{V} + c * {F}_{S} ) \qquad ( Formula 7 )$$

Here, a, b, c are hyperparameters, F_{N} represents a first interpolated feature, F_{V} represents a second interpolated feature corresponding to a global space, F_{S} represents a second interpolated feature corresponding to a instance space, and Fₐₗₗ represents an adjusted first interpolated feature. The first interpolated feature may be the same size in shape as the original image.

In the embodiments of the present disclosure, a third image feature is extracted from a first image, a fourth image feature is extracted from a second image, a second interpolated feature is generated by performing an interpolation process on the third image feature and the fourth image feature, and then the first interpolated feature is adjusted by using the second interpolated feature to obtain the adjusted first interpolated feature. In this process, the first interpolated feature is supplemented based on the second interpolated feature characterizing the detail information of the first image and the second image, so that the detail information of the transition image may be increased, thereby improving the effect of the generated transition image.

In one implementation, the decoding condition includes text information obtained from the first image and the second image, and the process of obtaining the text information includes the following operations.

Text description is performed on the first image and the second image respectively to obtain a first image text and a second image text.

The first image text and the second image text are input into a language model to obtain the text information.

Herein, the image description is to output a corresponding text description according to a provided image. The task of image description may include two parts: one is to encode an image to be described, and the other is to generate text according to the encoded information. The first image text is text obtained by performing the text description on the first image, and the second image text is text obtained by performing the text description on the second image. The method for realizing the image description is not specifically limited in the present disclosure, and may be determined according to the actual situation.

As shown in FIG. 2, an image description module (image caption) may be set in the image processing model. The image description module is used to convert image visual features extracted by the computer into high-level semantic information. The image description module may be a pre-trained model whose parameters do not need to be changed during the training process of the image processing model. Specifically, a same image description module may be used to describe the first image and the second image respectively, to obtain the first image text corresponding to the first image and the second image text corresponding to the second image.

After the first image text and the second image text are obtained, the language model may be used to extract more accurate text information from the first image text and the second image text. In an example, a large language model may be used as the language model, which may be GPT, LLaMA, ChatGLM, or the like. Since the large language model has the advantages of fast training speed, good interpretation, and strong generalization ability, the large language model may be used to integrate information in the first image text and the second image text to obtain text information. Specifically, both the first image text and the second image text may be input to the large language model, and the output of the large language model may be used as the text information.

A process in which the diffusion sub-model implements the decoding process of the first interpolated feature based on the decoding condition including the text information may be that: a vector is obtained by encoding the text information using a conditional encoder (the text information corresponding to a text vector), and the vector is input to a U-Net network of the diffusion sub-model based on a cross attention mechanism as a condition of the decoding process. Here, the U-Net network is the main body of the diffusion sub-model, which is used to generate the transition image under conditional guidance.

In the embodiments of the present disclosure, a text description is performed first on a first image and a second image, and then a first image text and a second image text obtained from the text description process are integrated through a language model to obtain text information. Because the language model has advantages, such as strong data processing ability and high accuracy of generated results, with this process, the ability of the text information to describe the first image and the second image is enhanced based on the language model, and then the effect of the transition image generated by using the text information may be improved.

In one implementation, a training process of the diffusion sub-model includes the following operations.

The first encoding process is performed on a first sample image and a second sample image respectively to obtain a first sample image feature and a second sample image features.

After first noise is added to the first sample image feature and the second sample image feature, the interpolation process is performed on the first sample image feature and the second sample image feature to obtain a first sample interpolated feature.

Based on the acquired decoding condition, the diffusion sub-model is used to perform the decoding process on the first sample interpolated feature, to obtain a sample transition image, and second noise removed by the decoding process corresponding to the sample transition image is determined.

According to a difference between the first noise and the second noise, a first loss is constructed, and the diffusion sub-model is trained according to the first loss to obtain the trained diffusion sub-model.

The first sample image and the second sample image may be arbitrarily selected natural images (such as images obtained by photographing) or computer-generated images. The sources of the first sample image and the second sample image are not limited in the present disclosure, and may be selected according to the practical situation. Similarly to the first image and the second image, objects in the first sample image and the second sample image are not limited in the present disclosure, and may be selected according to the practical situation. The object may be a person, a substance, an animal, or the like. Due to characteristics that, for example, the original sample images (the first sample image and the second sample image) are random and the original sample images do not need to be labeled, the original sample images available for selection in the present disclosure have a large selectable space.

Referring to the aforementioned generation process of the transition image, a sample transition image may be generated for each group of a first sample image and a second sample image. Specifically, the first encoding process may be performed on the first sample image and the second sample image respectively to obtain a first sample image feature corresponding to the first sample image and a second sample image feature corresponding to the second sample image. Next, the interpolation process may be performed on the first sample image feature and the second sample image feature after adding noise to the first sample image feature and the second sample image feature, to obtain a first sample interpolated feature. Finally, the first sample interpolated feature is decoded by using the diffusion sub-model, to obtain a sample transition image.

When the first sample interpolated feature is decoded, a decoding condition that controls the decoding process of the first sample interpolated feature may be acquired (refer to the method of acquiring the decoding condition of the first interpolated feature described above), and the first sample interpolated feature may be decoded by using the diffusion sub-model based on the decoding condition, to obtain a sample transition image.

In the training process, parameters of the diffusion sub-model may be adjusted according to the first loss. The first loss may be determined according to the difference between the first noise added in the first encoding process and the second noise removed in the decoding process. Specifically, the first loss of the diffusion sub-model may be as shown in Formula 8:

$${L}_{LDM} : min ( {( {‖ ε - {ε}_{θ} ( {F}_{all} , C ) ‖}_{2} )}^{2} ) \qquad ( Formula 8 )$$

Here, L_{LDM} represents an optimization target for the diffusion sub-model, F represents noise added to the first sample image and the second sample image, Fe represents a noise prediction network, t represents the number of steps of adding noise to the first sample image and the second sample image, C represents encoded data corresponding to the decoding condition, and Fₐₗₗ represents a first interpolated feature.

In the embodiments of the present disclosure, the diffusion sub-model is trained based on the first loss, and a transition image between any two images may be generated based on the trained diffusion sub-model, thereby improving the robustness of the image processing process.

In an implementation, a same group of a first sample image and a second sample image correspond to a plurality of sample transition images. The operation that the diffusion sub-model is trained according to the first loss to obtain the trained diffusion sub-model includes the following operations.

The sample transition images and a decoding condition, which correspond to the same group of a first sample image and a second sample image, are encoded respectively, to obtain a sample text feature of the decoding condition and sample image features of the sample transition images.

Based on matching degrees between the sample text feature and the sample image features, a target transition image is determined from the sample transition images using a sorting sub-model.

A second loss is constructed according to a difference between a sample image feature and a sample text feature, which correspond to the target transition image.

The diffusion sub-model and the sorting sub-model are jointly trained according to the first loss and the second loss, to obtain the trained diffusion sub-model and the trained sorting sub-model.

During the training process of the diffusion sub-model, the effect of the sample transition image output by the diffusion sub-model may be evaluated according to the decoding condition (usually text), to determine whether the sample transition image output by the diffusion sub-model meets the requirements. Specifically, the sample transition image and the decoding condition may be encoded respectively, and whether the sample transition image and the decoding condition match may be determined according to the matching operation between the obtained sample text feature corresponding to the decoding condition and the obtained sample image feature corresponding to the sample transition image.

Since images generated by the diffusion sub-model have diversity, the diffusion sub-model may generate a plurality of sample transition images for a same group of a first sample image and a second sample image. Therefore, the target transition image may be determined from the plurality of sample transition images by the sorting sub-model based on the matching degree between each sample transition image and the decoding condition. Further, the effect of the image output by the diffusion sub-model may be determined based on the difference between the sample text feature and the sample image feature of the target transition image. The operation of the sorting sub-model may include sorting the matching degrees between each sample transition image and the decoding condition to determine the target transition image whose sample image feature best matches the decoding condition from the plurality of template transition images.

As shown in FIG. 2, a sorting sub-model may be set in the image processing model. A decoding condition for controlling image generation may be encoded by a text encoding module in the sorting sub-model. A plurality of transition images output by the diffusion sub-model may be encoded by an image encoding module in the sorting sub-model. Further, the sorting module may be used to match the obtained sample text feature and a plurality of obtained sample image features and perform sorting based on the matching results. Then, whether the generated sample transition image meets the requirements may be determined according to the difference between the sample text feature and the sample image features of the target transition image. The loss constructed according to the difference between the sample image feature and the sample text feature of the target transition image is the second loss corresponding to the sorting sub-model. The process of calculating the second loss may be as shown in Formula 9:

$${L}_{sorting} = Contrastive ( {CLIP}_{image - encoder} ( {IP}_{image} ) , {C}_{s} ) \qquad ( Formula 9 )$$

Here, IP_{image} represents sample transition images output by the diffusion sub-model, CLIP_{image-encoder}(⋅) represents an encoding operation, Cₛ represents a sample text feature, Contrastive(⋅) represents a calculation contrast loss, and L_{sorting} represents a second loss of a sorting sub-model.

Further, joint training of the diffusion sub-model and the sorting sub-model may be performed, and the total loss corresponding to the joint training may be as follows:

$$Loss = {L}_{LDM} + {L}_{sorting} \qquad ( Formula 10 )$$

Here, Loss represents a total target loss, L_{LDM} represents a first loss of the diffusion sub-model, and L_{sorting} represents a second loss of the sorting sub-model.

For the image processing model in FIG. 2, the target loss in the above Formula 10 may be taken as the total loss of the entire image processing model, to adjust parameters of each module of the image processing model. In order to improve the training efficiency of the image processing model, the text encoding module and the image encoding module in FIG. 2 may be pre-trained models whose parameters do not need to be changed during the training process of the image processing model.

In the above model training process, through the joint training of the sorting sub-model and the diffusion sub-model, the trained sorting sub-model is more robust.

In an implementation, the operation that a target transition image is determined from the sample transition images using the sorting sub-model based on the matching degrees between the sample text feature and the sample image features includes the following operations.

A target image feature corresponding to the sample text feature is determined from a plurality of preset feature pairs containing a text feature and an image feature; and

The target transition image is determined from the sample transition images using the sorting sub-model based on distances between the target image feature and the sample image features.

The operation that the second loss is constructed according to the difference between the sample text feature and the sample image feature corresponding to the target transition image includes the following operations.

The second loss is constructed according to a distance between the sample image feature corresponding to the target transition image and the target image feature.

The target image feature may be an image feature in a plurality of preset pairs having sample text features, and each pair containing a text feature and an image feature. Specifically, a plurality of pairs of text features and image features may be preset. After the sample text feature is determined, a pair of a text feature and an image feature including the sample text feature may be determined from the pairs of text features and image features. The image feature in the pair of the text feature and the image feature may be used as the target image feature. A manner for obtaining the preset pairs of text features and image features may be as follows. Images and texts are mapped into a shared embedding space by performing contrast training on a large number of image-text pair data, so that a distance between an image and a text which are related is closer in the embedding space, and a distance between an image and a text which are unrelated is farther in the embedding space. After the contrast training is finished, the distance between an image and a text which are related in the embedding space should be smaller than the distance between an image and a text which are unrelated in the embedding space. Then the preset pairs of the text features and the image features may be obtained.

In an example, the preset pairs of text features and image features may be acquired by a trained Contrastive Language-Image Pre-Training (CLIP) model, and the image encoding module and the text encoding module may be a text encoder and an image encoder of the CLIP model, respectively. Specifically, the text information output by the language model may be encoded by the text encoder of the CLIP model to obtain the sample text feature, the sample transition image output by the diffusion sub-model may be encoded by the image encoder of the CLIP model to obtain the sample image feature, and the target image feature corresponding to the sample text feature may be determined according to the pairs of text features and image features determined by the CLIP model.

Further, feature distances between the target image feature and sample image features of a plurality of sample transition images corresponding to the same group of a first image and a second image may be calculated, and the feature distances may be sorted using the sorting sub-model, and a target transition image may be selected from the plurality of sample transition images. A feature distance corresponding to the target transition image may be the smallest one of the feature distances. After the target transition image is determined, the second loss corresponding to the sorting sub-model may be determined according to the feature distance corresponding to the target transition image.

In the embodiments of the present disclosure, the second loss is determined by performing matching between the sample image feature of the sample transition image output by the diffusion sub-model and the target image feature, so that the first loss and the second loss may be combined to improve the effect of the transition image output by the image processing process.

As can be seen, in the embodiment of the present disclosure, a first encoding process is performed on the first image and the second image which are to be interpolated, and an interpolation process is performed on the first image feature and the second image feature which are obtained through encoding, to obtain the first interpolated feature, and then a decoding process is performed on the first interpolated feature, to generate a transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

It should be noted that the image processing method according to the embodiments of the present disclosure may be executed by an image processing apparatus or a control module for executing the image processing method in the image processing apparatus. In the embodiments of the present disclosure, the image processing apparatus provided in the embodiments of the present disclosure will be described by taking the image processing method executed by the image processing apparatus as an example.

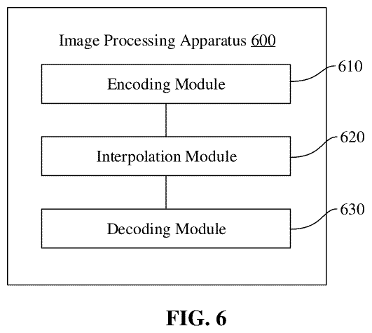

Corresponding to the image processing method described above, one or more embodiments of the present disclosure further provide an image processing apparatus based on the same technical concept. FIG. 6 is a schematic structural diagram of an image processing apparatus according to one or more embodiments of the present disclosure. As shown in FIG. 6, the image processing apparatus 600 includes an encoding module 610, an interpolation module 620 and a decoding module 630.

The encoding module 610 is configured to perform a first encoding process on a first image and a second image to obtain a first image feature and a second image feature.

The interpolation module 620 is configured to perform an interpolation process on the first image feature and the second image feature to obtain a first interpolated feature.

The decoding module 630 is configured to perform a decoding process on the first interpolated feature to obtain a transition image, and insert the transition image between the first image and the second image.

The image processing apparatus according to the embodiments of the present disclosure performs the first encoding process on the first image and the second image which are to be interpolated, performs the interpolation process on the first image feature and the second image feature which are obtained by encoding, to obtain the first interpolated feature, and further performs the decoding process on the first interpolated feature to generate the transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

It should be noted that, since the embodiment of the image processing apparatus in the present disclosure and the embodiment of the image processing method in the present disclosure are based on the same inventive concept, the specific implementation of the embodiment may be referred to the implementation of the corresponding image processing method described above, and redundancy will not be repeated.

Modules in the above-described image processing apparatus may be fully or partially implemented by software, hardware, and combinations thereof. The above-described modules may be embedded in or independent of a processor of the terminal device or a processor of the server in a form of hardware, or may be stored in a memory of the terminal device or a memory of the server in a form of software, so that the processor may call and execute the operations corresponding to the above-described modules.

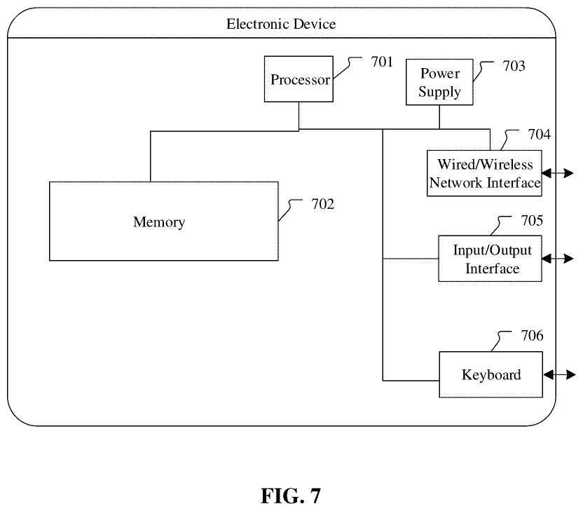

Further, corresponding to the above-described image processing method, based on the same technical concept, one or more embodiments of the present disclosure further provide an electronic device for executing the above-described image processing method. FIG. 7 is a schematic structural diagram of the electronic device provided by one or more embodiments of the present disclosure.

Based on the same technical concept, one or more embodiments of the present disclosure also provide an electronic device, as shown in FIG. 7. Electronic devices may vary greatly depending on configuration or performance. The electronic device may include one or more processors 701 and a memory 702 having one or more storage applications or data stored thereon. The memory 702 may be temporary storage or persistent storage. The application program stored in the memory 702 may include one or more modules (not shown). Each module may include a series of computer-executable instructions for the electronic device. Further, the processor 701 may be arranged to communicate with the memory 702 to execute a series of computer-executable instructions in the memory 702 on the electronic device. The electronic device may also include one or more power supplies 703, one or more wired or wireless network interfaces 704, one or more input/output interfaces 705, and one or more keyboards 706.

In a specific embodiment, the electronic device includes a memory, and one or more programs. Herein, the one or more programs are stored in the memory, and the one or more programs may include one or more modules. Each module may include a series of computer-executable instructions for the electronic device and may be configured to be executed by one or more processors, the one or more programs include computer-executable instructions for the following operations:

A first encoding process is performed on a first image and a second image to obtain a first image feature and a second image feature.

An interpolation process is performed on the first image feature and the second image feature to obtain a first interpolated feature.

A decoding process is performed on the first interpolated feature to obtain a transition image, and the transition image is inserted between the first image and the second image.

The electronic device according to the embodiments of the present disclosure performs the first encoding process on the first image and the second image which are to be interpolated, performs the interpolation process on the first image feature and the second image feature which are obtained by encoding, to obtain the first interpolated feature, and further performs the decoding process on the first interpolated feature to generate the transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

It should be noted that the embodiment of the electronic device in the present disclosure and the embodiment of the image processing method in the present disclosure are based on the same inventive concept, and thus the specific implementation of the embodiment can be referred to the implementation of the corresponding image processing method described above, and the redundancy will not be repeated.

Further, corresponding to the image processing method described above, based on the same technical concept, one or more embodiments of the present disclosure further provide a storage medium for storing computer-executable instructions. In a specific embodiment, the storage medium may be a U disk, an optical disk, a hard disk, or the like. When the computer-executable instructions stored in the storage medium are executed by a processor to perform the following operations.

A first encoding process is performed on a first image and a second image respectively to obtain a first image feature and a second image feature.

An interpolation process is performed on the first image feature and the second image feature to obtain a first interpolated feature.

A decoding process is performed on the first interpolated feature to obtain a transition image, and the transition image is inserted between the first image and the second image.

The computer-executable instruction stored in the storage medium provided by one or more embodiments of the present disclosure, when executed by the processor, performs the first encoding process on the first image and the second image which are to be interpolated, performs the interpolation process on the first image feature and the second image feature which are obtained by encoding, to obtain the first interpolated feature, and further performs the decoding process on the first interpolated feature to generate the transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

It should be noted that the embodiment of the storage medium in the present disclosure and the image processing method in the present disclosure are based on the same inventive concept, and thus the specific implementation of the embodiment may be referred to the implementation of the corresponding image processing method described above, and the redundancy will not be repeated.

Further, corresponding to the image processing method described above, based on the same technical concept, one or more embodiments of the present disclosure further provide a computer program product. The computer program product includes a computer program. The computer program, when executed by a processor, performs the following operations.

A first encoding process is performed on a first image and a second image respectively to obtain a first image feature and a second image feature.

An interpolation process is performed on the first image feature and the second image feature to obtain a first interpolated feature.

A decoding process is performed on the first interpolated feature to obtain a transition image, and the transition image is inserted between the first image and the second image.

The computer program in the computer program product according to one or more embodiments of the present disclosure, when executed by the processor, performs the first encoding process on the first image and the second image which are to be interpolated, performs the interpolation process on the first image feature and the second image feature which are obtained by encoding, to obtain the first interpolated feature, and further performs the decoding process on the first interpolated feature to generate the transition image. With this process, interpolation between images is converted into interpolation between image features. Compared with the original image, the amount of information of image features is greatly reduced. Therefore, the difficulty of realizing the image interpolation process is effectively reduced and the accuracy of the generated transition image is improved. Further, the interpolation operation for any two images is realized, so that the robustness of generating the transition image is improved.

It should be noted that the embodiment of the computer program product in the present disclosure and the embodiment of the image processing method in the present disclosure are based on the same inventive concept, and thus the specific implementation of the embodiment may be referred to the implementation of the corresponding image processing method described above, and the redundancy will not be repeated.

Specific embodiments of the present disclosure have been described above. Other embodiments are within the scope of the appended claims. In some cases, the acts or steps recited in the claims may be performed in a different order than in the embodiments and the desired results may still be achieved. Additionally, the processes depicted in the drawings do not necessarily require the particular order or sequential order shown to achieve the desired results. In some embodiments, multitasking and parallel processing are also possible or may be advantageous.

In the 1990s, for improvements of a technology, it may clearly distinguish between hardware improvements (for example, improvements of circuit structures such as diodes, transistors, switches, etc.) and software improvements (improvements of a method flow). However, with the development of technology, the improvement of many method flows today may be regarded as a direct improvement of hardware circuit structure. Designers almost always get the corresponding hardware circuit structure by programming the improved method flow into the hardware circuit. Therefore, it cannot be said that an improvement of a method flow cannot be realized by hardware entity modules. For example, a Programmable Logic Device (PLD), such as a Field Programmable Gate Array (FPGA), is one such integrated circuit whose logic function is determined by the user programming the device. Designers program to “integrate” a digital system on a PLD, instead of asking chip manufacturers to design and manufacture special integrated circuit chips. Moreover, nowadays, instead of manually making integrated circuit chips, this kind of programming is mostly implemented by “logic compiler” software, which is similar to the software compiler used in program development and writing. Further, the original code before compilation has to be written in a specific programming language, which is called Hardware Description Language (HDL). There is not only one HDL, but many kinds, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL). Currently, the most commonly used ones are Very-High-Speed Integrated Circuit Hardware Description Language (VHDL) and Verilog. It will also be clear to those skilled in the art that hardware circuits for implementing the logic method flow may be easily obtained only by logic programming the method flow in the above-described hardware description languages and programming it into an integrated circuit.

A controller may be implemented in any suitable manner. For example, the controller may take the form of, for example, a microprocessor or a processor and a computer readable medium storing computer readable program codes (e.g. software or firmware) executable by the processor (or microprocessor), a logic gate, a switch, an application specific integrated circuit (ASICs), a programmable logic controller and an embedded microcontroller. Examples of the controller include, but are not limited to, the following microcontrollers: ARC 625D, Atmel AT91SAM, Microchip PIC 18F26K20, and Silicone Labs C8051F320. A memory controller may also be implemented as part of a control logic of a memory. It is also known to those skilled in the art that, in addition to implementing the controller in purely computer-readable program codes, it is entirely possible to logically program the method steps such that the controller implements the same function in the form of logic gates, switches, application specific integrated circuits, programmable logic controllers, embedded microcontrollers, and the like. Such a controller may thus be regarded as a hardware component, and a means for implementing various functions included in the hardware component may also be regarded as a structure within the hardware component. Alternatively, the means for implementing various functions may be regarded as software modules implementing the method or structures within the hardware component.

The system, apparatus, module, or unit described in the above embodiments may be implemented by a computer chip or entity, or by a product having a certain function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or any combination of the foregoing.

For convenience of description, when the above apparatus is described, it is divided into various units in terms of functions and described separately. Alternatively, when implementing the embodiments of the present disclosure, the functions of various units may be implemented in one or more software and/or hardware.

It will be appreciated by those skilled in the art that one or more embodiments of the present disclosure may be provided as methods, systems, or computer program products. Accordingly, one or more embodiments of the present disclosure may take the form of an entirely hardware embodiment, an entirely software embodiment, or an embodiment combining software and hardware aspects. Moreover, the present disclosure may take the form of a computer program product implemented on one or more computer-usable storage media (including, but not limited to, magnetic disk storages, CD-ROMs, optical memories, etc.) containing computer-usable program code therein.

The present disclosure is described with reference to flowcharts and/or block diagrams of methods, apparatus (systems), and computer program products according to embodiments of the present disclosure. It should be understood that each flow and/or block in the flowcharts and/or block diagrams, as well as combinations of the flowcharts and/or block diagrams in the flowcharts and/or block diagrams, may be implemented by computer program instructions. These computer program instructions may be provided to a processor of a general purpose computer, a special purpose computer, an embedded processor, or other programmable data processing apparatus to produce a machine such that the instructions executed by a processor of the computer or other programmable data processing apparatus produce means for implementing the functions specified in one or more flows of the flowchart diagrams and/or one or more blocks of the block diagrams.

These computer program instructions may also be stored in a computer-readable memory capable of directing a computer or other programmable data processing apparatus to operate in a particular manner such that the instructions stored in the computer-readable memory produce an article of manufacture comprising instruction means for implementing the functions specified in one or more flow of the flowcharts and/or one or more blocks of the block diagrams.

These computer program instructions may also be loaded onto a computer or other programmable data processing apparatus such that a series of operational steps are performed on the computer or other programmable apparatus to produce a computer-implemented process, such that the instructions executed on the computer or other programmable apparatus provide steps for implementing the functions specified in one or more flows of the flowcharts and/or one or more blocks of the block diagrams.

In one typical configuration, the computing device includes one or more Central Processor Units (CPUs), input/output interfaces, network interfaces, and memories.

The memory may include a non-persistent memory, a Random Access Memory (RAM) and/or a non-volatile memory in a computer-readable medium, such as a Read-Only Memory (ROM) or a flash RAM. The memory is an example of a computer-readable medium.

Computer-readable media, including permanent and non-permanent, removable and non-removable media, may store information by any method or technique. The information may be computer-readable instructions, data structures, modules of programs, or other data. Examples of storage media for a computer include, but are not limited to, phase change RAMs (PRAMs), static RAMs (SRAMs), dynamic RAMs (DRAMs), other types of RAMs (RAMs), read-only memories (ROMs), electrically erasable programmable ROMs (EEPROMs), flash memories or other memory technologies, compact disc RAMs (CD-ROMs), digital versatile discs (DVDs) or other optical storages, magnetic cassettes, magnetic tapes, magnetic disk storages or other magnetic storage devices, or any other non-transmission medium that may be used to store information accessible by a computing device. As defined herein, the computer-readable media does not include transitory media, such as modulated data signals and carrier waves.

It should also be noted that the terms “including”, “comprising” or any other variation thereof are intended to encompass a non-exclusive inclusion such that a process, method, article, or apparatus including a series of elements includes not only those elements, but also other elements not explicitly listed, or elements inherent to such a process, method, article, or apparatus. Without further limitation, an element defined by the statement “including a . . . ” does not preclude the presence of additional identical elements in a process, method, article, or apparatus including the element.

One or more embodiments of the present disclosure may be described in the general context of computer-executable instructions executed by a computer, such as program modules. Generally, the program modules include routines, programs, objects, components, data structures, and the like that perform particular tasks or implement particular abstract data types. One or more embodiments of the present disclosure may also be practiced in distributed computing environments in which tasks are performed by remote processing devices connected through a communication network. In the distributed computing environment, program modules may be located in local and remote computer storage media, including storage devices.

Embodiments in the present disclosure are described in a stepwise manner, and the same and similar parts between the embodiments may be referred to each other, and the differences between the embodiment and other embodiments are emphasized. In particular, since the system embodiment is basically similar to the method embodiment, the description of which is relatively simple, and reference may be made to the description of part of the method embodiment for related details.

The foregoing is merely an embodiment of the present document and is not intended to limit the present document. Various modifications and variations of the present document will be apparent to those skilled in the art. Any modification, equivalent substitution, improvement, etc. made within the spirit and principle of this document should be included within the scope of the claims herein.

1. An image processing method, comprising:
performing a first encoding process on a first image and a second image to obtain a first image feature and a second image feature;
performing an interpolation process on the first image feature and the second image feature to obtain a first interpolated feature; and
performing a decoding process on the first interpolated feature to obtain a transition image, and inserting the transition image between the first image and the second image.

2. The method of claim 1, wherein performing the interpolation process on the first image feature and the second image feature to obtain the first interpolated feature comprises:
adding noise to the first image feature and the second image feature to obtain a noise-added first image feature and a noise-added second image feature; and
performing interpolation process on the noise-added first image feature and the noise-added second image feature to obtain the first interpolated feature.

3. The method of claim 2, wherein performing the decoding process on the first interpolated feature to obtain the transition image comprises:
acquiring a decoding condition for the first interpolated feature; and
performing, based on the decoding condition, the decoding process on the first interpolated feature using a diffusion sub-model to obtain the transition image, wherein the decoding process comprises a noise removal process.

4. The method of claim 3, wherein performing, based on the decoding condition, the decoding process on the first interpolated feature using the diffusion sub-model to obtain the transition image comprises:
performing a second encoding process on the first image and the second image to obtain a third image feature and a fourth image feature;
performing an interpolation process on the third image feature and the fourth image feature to obtain a second interpolated feature;
adjusting, based on the second interpolated feature, the first interpolated feature to obtain an adjusted first interpolated feature; and
performing, based on the decoding condition, the decoding process on the adjusted first interpolated feature using the diffusion sub-model, to obtain the transition image.

5. The method of claim 4, wherein the second encoding process comprises M encoding types and M is a positive integer greater than 1, performing the second encoding processing on the first image and the second image to obtain the third image features and the fourth image features comprises:
performing, based on the M encoding types, the second encoding processing on the first image and the second image to obtain M types of third image features and M types of fourth image features,
and wherein performing the interpolation process on the third image feature and the fourth image feature to obtain the second interpolated feature comprises:
performing the interpolation process on a third image feature and a fourth image feature belonging to a same encoding type, to obtain M types of second interpolated features.

6. The method of claim 3, wherein the decoding condition comprises text information obtained from the first image and the second image, and a process of obtaining the text information comprises:
performing a text description on the first image and the second image to obtain first image text and second image text; and
inputting the first image text and the second image text into a language model to obtain the text information.

7. The method of claim 3, wherein a training process of the diffusion sub-model comprises:
performing the first encoding process on a first sample image and a second sample image to obtain a first sample image feature and a second sample image feature;
after adding first noise to the first sample image feature and the second sample image feature, performing the interpolation process on the first sample image feature and the second sample image feature to obtain a first sample interpolated feature;
performing, based on an acquired decoding condition, the decoding process on the first sample interpolated feature using the diffusion sub-model to obtain a sample transition image, and determining a second noise removed by the decoding process corresponding to the sample transition image; and
constructing, according to a difference between the first noise and the second noise, a first loss, and training, according to the first loss, the diffusion sub-model to obtain a trained diffusion sub-model.

8. The method of claim 7, wherein a same group of a first sample image and a second sample image correspond to a plurality of sample transition images, and training, according to the first loss, the diffusion sub-model to obtain the trained diffusion sub-model comprises:
respectively encoding the sample transition images and the decoding condition, which correspond to the same group of a first sample image and a second sample image, to obtain sample image features of the sample transition images and a sample text feature of the decoding condition and;
determining, based on matching degrees between the sample text feature and the sample image features, a target transition image from the sample transition images using a sorting sub-model;
constructing a second loss according to a difference between a sample image feature and a sample text feature, which correspond to the target transition image; and
jointly training, according to the first loss and the second loss, the diffusion sub-model and the sorting sub-model to obtain the trained diffusion sub-model and a trained sorting sub-model.

9. An electronic device, comprising:
a processor; and,
a memory configured to store computer-executable instructions, wherein the computer-executable instructions are configured to be executed by the processor, and the computer-executable instructions comprises following operations:
performing a first encoding process on a first image and a second image to obtain a first image feature and a second image feature;
performing an interpolation process on the first image feature and the second image feature to obtain a first interpolated feature; and
performing a decoding process on the first interpolated feature to obtain a transition image, and inserting the transition image between the first image and the second image.

10. The electronic device of claim 9, wherein performing the interpolation process on the first image feature and the second image feature to obtain the first interpolated feature comprises:
adding noise to the first image feature and the second image feature to obtain a noise-added first image feature and a noise-added second image feature; and
performing interpolation process on the noise-added first image feature and the noise-added second image feature to obtain the first interpolated feature.

11. The electronic device of claim 10, wherein performing the decoding process on the first interpolated feature to obtain the transition image comprises:
acquiring a decoding condition for the first interpolated feature; and
performing, based on the decoding condition, the decoding process on the first interpolated feature using a diffusion sub-model to obtain the transition image, wherein the decoding process comprises a noise removal process.

12. The electronic device of claim 11, wherein performing, based on the decoding condition, the decoding process on the first interpolated feature using the diffusion sub-model to obtain the transition image comprises:
performing a second encoding process on the first image and the second image to obtain a third image feature and a fourth image feature;
performing an interpolation process on the third image feature and the fourth image feature to obtain a second interpolated feature;
adjusting, based on the second interpolated feature, the first interpolated feature to obtain an adjusted first interpolated feature; and
performing, based on the decoding condition, the decoding process on the adjusted first interpolated feature using the diffusion sub-model, to obtain the transition image.

13. The electronic device of claim 12, wherein the second encoding process comprises M encoding types and M is a positive integer greater than 1, performing the second encoding processing on the first image and the second image to obtain the third image features and the fourth image features comprises:
performing, based on the M encoding types, the second encoding processing on the first image and the second image to obtain M types of third image features and M types of fourth image features,
and wherein performing the interpolation process on the third image feature and the fourth image feature to obtain the second interpolated feature comprises:
performing the interpolation process on a third image feature and a fourth image feature belonging to a same encoding type, to obtain M types of second interpolated features.

14. The electronic device of claim 11, wherein the decoding condition comprises text information obtained from the first image and the second image, and a process of obtaining the text information comprises:
performing a text description on the first image and the second image to obtain first image text and second image text; and
inputting the first image text and the second image text into a language model to obtain the text information.

15. The electronic device of claim 11, wherein a training process of the diffusion sub-model comprises:
performing the first encoding process on a first sample image and a second sample image to obtain a first sample image feature and a second sample image feature;
after adding first noise to the first sample image feature and the second sample image feature, performing the interpolation process on the first sample image feature and the second sample image feature to obtain a first sample interpolated feature;
performing, based on an acquired decoding condition, the decoding process on the first sample interpolated feature using the diffusion sub-model to obtain a sample transition image, and determining a second noise removed by the decoding process corresponding to the sample transition image; and
constructing, according to a difference between the first noise and the second noise, a first loss, and training, according to the first loss, the diffusion sub-model to obtain a trained diffusion sub-model.

16. The electronic device of claim 15, wherein a same group of a first sample image and a second sample image correspond to a plurality of sample transition images, and training, according to the first loss, the diffusion sub-model to obtain the trained diffusion sub-model comprises:
respectively encoding the sample transition images and the decoding condition, which correspond to the same group of a first sample image and a second sample image, to obtain sample image features of the sample transition images and a sample text feature of the decoding condition and;
determining, based on matching degrees between the sample text feature and the sample image features, a target transition image from the sample transition images using a sorting sub-model;
constructing a second loss according to a difference between a sample image feature and a sample text feature, which correspond to the target transition image; and
jointly training, according to the first loss and the second loss, the diffusion sub-model and the sorting sub-model to obtain the trained diffusion sub-model and a trained sorting sub-model.

17. A non-transitory computer-readable storage medium for storing computer-executable instructions, wherein the computer-executable instructions cause a computer to perform following operations:
performing a first encoding process on a first image and a second image to obtain a first image feature and a second image feature;
performing an interpolation process on the first image feature and the second image feature to obtain a first interpolated feature; and
performing a decoding process on the first interpolated feature to obtain a transition image, and inserting the transition image between the first image and the second image.

18. The non-transitory computer-readable storage medium of claim 17, wherein performing the interpolation process on the first image feature and the second image feature to obtain the first interpolated feature comprises:
adding noise to the first image feature and the second image feature to obtain a noise-added first image feature and a noise-added second image feature; and
performing interpolation process on the noise-added first image feature and the noise-added second image feature to obtain the first interpolated feature.

19. The non-transitory computer-readable storage medium of claim 18, wherein performing the decoding process on the first interpolated feature to obtain the transition image comprises:
acquiring a decoding condition for the first interpolated feature; and
performing, based on the decoding condition, the decoding process on the first interpolated feature using a diffusion sub-model to obtain the transition image, wherein the decoding process comprises a noise removal process.

20. The non-transitory computer-readable storage medium of claim 19, wherein performing, based on the decoding condition, the decoding process on the first interpolated feature using the diffusion sub-model to obtain the transition image comprises:
performing a second encoding process on the first image and the second image to obtain a third image feature and a fourth image feature;
performing an interpolation process on the third image feature and the fourth image feature to obtain a second interpolated feature;
adjusting, based on the second interpolated feature, the first interpolated feature to obtain an adjusted first interpolated feature; and
performing, based on the decoding condition, the decoding process on the adjusted first interpolated feature using the diffusion sub-model, to obtain the transition image.
